(19) United States
(12) Patent Application Publication
(10) Pub. No.: US 2003/0111170 A1
(43) Pub. Date: Jun. 19, 2003

(54) Filter body and production method thereof and fluid filter

(75) Inventors: Yoshihiro Oohashi, Kariya-shi (JP); Tadashi Ogawa, Kariya-shi (JP); Shogo Oda, Kariya-shi (JP)

Correspondence Address: OLIFF & BERRIDGE, PLC, P.O. BOX 19928, ALEXANDRIA, VA, 22320, US

(73) Assignee: Toyoda Boshoku Corporation, Kariya-shi (JP)

(21) Appl. No.: 10/314,262

(22) Filed: Dec. 9, 2002

(30) Foreign Application Priority Data
Dec. 13, 2001 (JP) 2001-380704

(51) Int. Cl. B32B 31/00

(52) U.S. Cl. 156/275.1; 210/493.5

(57) ABSTRACT

A filter according to the invention includes a filter body having a cylindrical element having ribs extending radially in which inner surfaces of the ribs are joined with adhesive at the vicinity of the upper edge portion and the lower edge portion a casing that stores the filter body, a relief valve and a check valve that support the filter body, and seal bodies that are formed by photo-curing resin and are provided between an upper surface portion of the element and the relief valve and between a lower surface portion of the element and the check valve. In the element, photo-curing resin is applied to an upper surface portion and a lower surface portion of a cylindrical folded body having ribs extending radially, and after that, a transparent mold is placed on the upper surface portion and the lower surface portion of the folded body, and the photo-curing resin is photo-cured in this condition and a seal body is produced.

### INCORPORATION BY REFERENCE

The disclosure of Japanese Patent Application No. 2001-380704 filed on Dec. 13, 2001, including the specification, drawings and abstract is incorporated herein by reference in its entirety.

### BACKGROUND OF THE INVENTION

1. Field of Invention

The invention is related to a fluid filter for filtering foreign matter that is mixed in a fluid. More particularly, the invention is related to a fluid filter that can reliably seal between a filter body and a storage body.

2. Description of Related Art

A fluid filter (hereinafter referred to simply as “filter”) that is used when filtering fluid (hereinafter referred to simply as “fluid”) such as oil, air, etc., for example, as shown in FIG. 16, has been known. Namely, a cylinder shaped filter body 105 that is formed with a plurality of predetermined ribs is stored in an inner portion of a casing that is open at one end. A surface of a side of the casing that is open is closed by a bottom plate 103 that has a flow inlet 101 and a flow outlet 102. The fluid such as oil that flows into a flow channel 106 from the fluid inlet 101 of the bottom plate 103 flows through the filter body 105 from the outer portion of the filter body 105 and is filtered, and reaches an inner portion of the filter body 105. When the filter is used to filter engine oil, the filter engine oil passes through a flow channel 107 and is supplied to the engine lubrication system by the flow outlet 102 of the bottom plate 103. At this time, if the seal of the edge portion in the axial direction of the element is insufficient, the engine oil that is not filtered flows into the flow channel 107. Leakage such as this from the flow channel 106 to the flow channel 107 is a cause of failure in the engine lubrication. Therefore, it is necessary to hermetically seal the inner surfaces of the rib of the filter body 105 at the upper edge portion and the lower edge portion or the vicinity thereof, and further, it is necessary to sufficiently seal the space formed between the upper surface portion and the casing 104 and the space formed between the lower surface portion of the filter body and (the bottom plate.

Japanese Patent Application Laid-Open No. 10-57716 discloses a method for producing a cylindrical element, in which a thermal melting type adhesive that can be reactivated is used to form a cylindrical element having ribs that extend radially, whereby the need to apply an adhesive is eliminated when setting a sealing member on an edge portion of the element. A production process for the cylindrical element is as follows. Namely, heated thermal melting type adhesive is applied to both edge portions of the elongate side of an elongate sheet shaped paper filter medium. Next, after the folding process during which the paper filter medium is folded, by applying pressure to and attaching inner surfaces of each trough portion of the filter medium that has been folded, the element is formed into a cylindrical shape having ribs that extend radially. At that time, the thermal melting type adhesive that is in the trough portions of the filter medium is pushed out toward each axial edge portion side of the cylinder, whereby beads are formed. The thermal melting type adhesive can be reactivated by the application of heat, in other words, its adhesive abilities can be restored (hereinafter, this ability will be referred to as reactivation). Next, heat is reapplied to the beads after the filter medium is formed into the cylindrical shape as mentioned above, and a sealing member is attached by pressure to each edge portion where beads have formed.

Also, Japanese Patent Application Laid-Open No. 8-512242 discloses an filter medium having ribs that extend radially to which an endplate is attached at the bottom edge portion thereof using photo-curing adhesive. The assembling method in this case is as follows. First, photo-curing adhesive is inserted in a groove portion that is formed on the endplate made of a material that is optically transparent. Next, the bottom edge portion of the filter medium is inserted in the groove portion, and the photo-curing adhesive is applied to the filter medium. After that, the endplate is attached by pressure in a predetermined direction to the filter medium. Finally, light is applied to the endplate from a light source, and the photo-curing adhesive that was applied to the filter medium is hardened.

According to Japanese Patent Application Laid-Open No. 10-57716, however, it is necessary to apply thermal melting adhesive to each end portion prior to the folding process of the filter paper, and it is necessary to form beads during the folding process. When folding the filter paper into a cylindrical shape having ribs that extend radially, from the perspective of productivity, it is necessary to attach by pressure inner surfaces of each rib of the filter medium while both edge portions are fixed in a predetermined direction using a jig or the like. When both edges are fixed with a jig, however, there is a problem that beads are not formed.

Also, when using a thermal melting adhesive such as polyamide with reactivation, there is a problem that the filter medium formed in a cylindrical shape having ribs that extend radially is deformed due to leaving the filter medium in high temperatures. Further, because it is necessary to maintain the thermal melting adhesive at a high temperature during activation and reactivation, this production method requires complex and expensive equipment. Also, adhesives such as thermal melting adhesive require much time for the production process because the hardening takes much time.

In addition, in Japanese Patent Application Laid-Open No. 8-512242, photo-curing resin is used. However, the endplate is attached to the lower edge portion of the filter medium using the photo-curing resin.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements wherein:

FIG. 1 is a lateral view of a half-section of an oil filter that shows the structure of the oil filter according to an embodiment.

FIG. 2 is an explanatory view showing a filter that has a seal portion formed on a cylindrical element having ribs that extend radially according to a first embodiment.

FIG. 3 is a lateral view of a half-section of a filter body according to the first embodiment.

FIG. 4 is a top view of the filter body according to the first embodiment.

FIG. 5 is a lateral view of a half-section of the element shown in FIG. 4.

FIG. 6 is a top view showing the condition in which photo-curing resin is applied to the element shown in FIG. 4.

FIG. 7 is a lateral view of a half-section of the element in FIG. 6.

FIG. 8 is a lateral view of a half-section of the mold used when forming a seal portion on the element.

FIG. 9 is an explanatory view explaining the method for forming the seal portion on the surface of the element according to the first embodiment.

FIG. 10 is a top view of the filter body according to a second embodiment.

FIG. 11 is a lateral view of a half-section of the filter body in FIG. 10.

FIG. 12 is an explanatory view showing the production method for the filter body according to the second embodiment.

FIG. 13 is a top view of the filter body according to a third embodiment.

FIG. 14 is a lateral view of a half-section of the filter body in FIG. 13.

FIG. 15 is an explanatory view showing the production method of the filter body according to a fourth embodiment.

FIG. 16 is a lateral sectional view of a conventional fluid filter.

### DETAILED DESCRIPTION OF PREFERRED EMBODIMENTS

Embodiments of the invention will be explained using a so-called spin-on type oil filter as an example with reference to the drawings.

Further, the spin-on type oil filter is positioned using appropriate fixed means at a certain point of an engine lubrication system circuit of vehicles such as automobiles and filters foreign matter, such as dust, metal pieces and sludge, that is mixed in the engine oil.

[First Embodiment]

(1) Oil Filter Structure

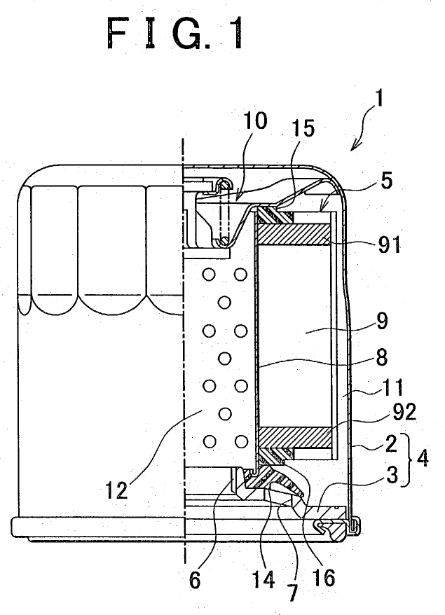

As shown in FIG. 1, an oil filter 1 basically includes a casing 4 (storage body), a filter body 5 that is stored in the casing 4, a relief valve 10 (it can be regarded as the upper support portion of the invention) and a check valve 14 (it can be regarded as the lower support portion of the invention) for sandwiching and holding the filter body. The filter body 5 includes a cylindrical element 9 described later, a seal portion 15 that seals between the upper surface portion of the filter body 5 and the relief valve 10, and a seal portion 16 that seals between the lower surface portion of the filter body 5 and the check valve 14.

The casing 4 includes a case member 2 for storing the filter body, and a bottom plate 3 for capping the opening portion that is formed in the lower portion of the case member.

An oil flow outlet 6 is formed at a center portion of the bottom plate 3 of the casing 4. In addition, a plurality of oil flow inlets 7 are formed at predetermined intervals along the circumferential direction around the oil flow outlet 6.

Also, the cylindrical element 9 is sandwiched and held by the seal portion 16 that is positioned between the check valve 14 as well as the bottom plate 3 and the lower surface of the cylindrical element 9, and the seal portion 15 that is positioned between the relief valve 10 and the upper surface of the filter body 5. The filter body 5 is positioned in the case member 2 on the same axis as the case member 2. Also, the space inside the casing 4 is divided into (an oil passage II that is the upper flow side of the filter body 5 and communicates with the oil flow inlets 7) and (an oil passage 12 that is the lower flow side of the filter body 5 and communicates with the oil flow outlet 6) by the cylindrical element 9 and the seal portions 15 and 16 formed in the cylindrical element 9. In other words, pressure is applied to the seal portions 15 and 16 formed on the element 9 so that they contact the relief valve 10 and the check valve 14, respectively. Thus, they seal between the oil passage 11 and the oil passage 12.

(2) Filter Body Structure

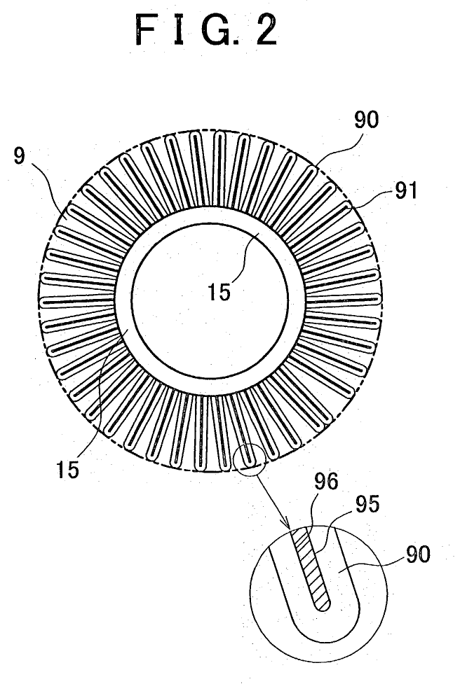

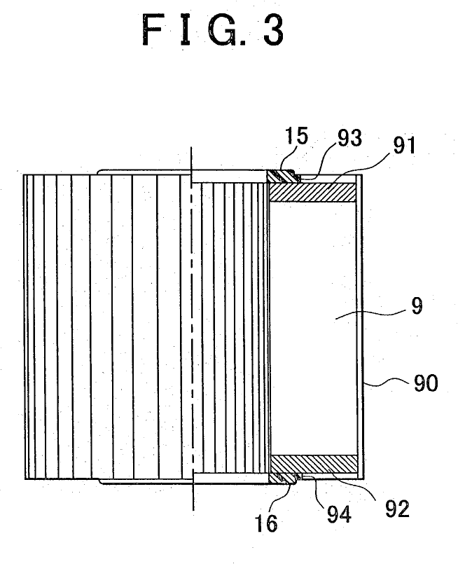

Also, as shown in FIG. 2 and FIG. 3, the filter body 5 includes the cylindrical element 9 having ribs 90 that extend radially and annular seal portions 15 and 16. Inner surfaces 95, 96 of rib 90 are attached each other through an adhesive layer at an upper edge portion vicinity 91 and a lower edge portion vicinity 92. The annular seal portions 15 and 16 are formed on the inner periphery side edge portions of the upper surface and the lower surface of the element 9.

Also, the seal portions 15 and 16 are hard formed of photo-curing resin (ultraviolet-curing type acrylic resin or ultraviolet-curing type acrylic silicone resin). Also, the seal portions 15 and 16 that are hard formed have rubber elasticity, and the hardness is approximately 10 to 70 in accordance with ISO 7619, that is, approximately 10 to 70 in accordance with JIS K 7215.

(3) Filter Body Production Method and Installation Thereof

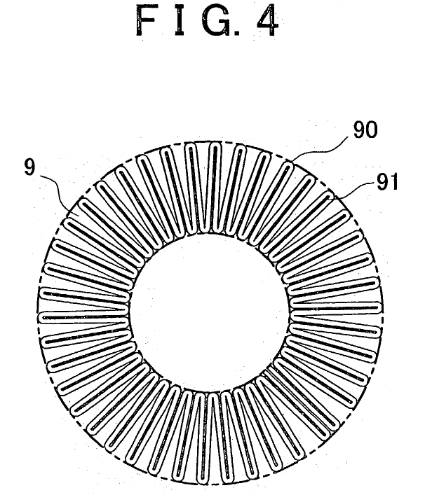

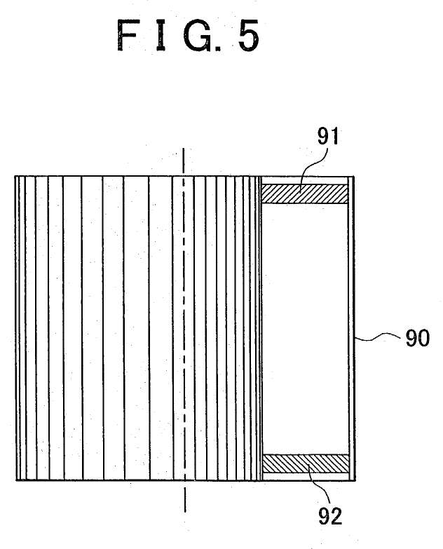

First, as shown in FIG. 4 and FIG. 5, a plurality of ribs 90 is formed by folding the filter medium that is made of non-woven fabric, and the filter medium is formed into a cylindrical shape having ribs that extend radially. A non-photo-curing adhesive (normal thermoplastic adhesive and thermal melting adhesive) is applied to the upper edge portion vicinity 91 and the lower edge portion vicinity 92 of the inner surfaces 95, 96 of the ribs 90, after which it is dried or hardened, and an element 9 is produced. Further, the adhesive is not applied to a portion above the upper edge portion vicinity 91, that is, an upper edge portion 93.

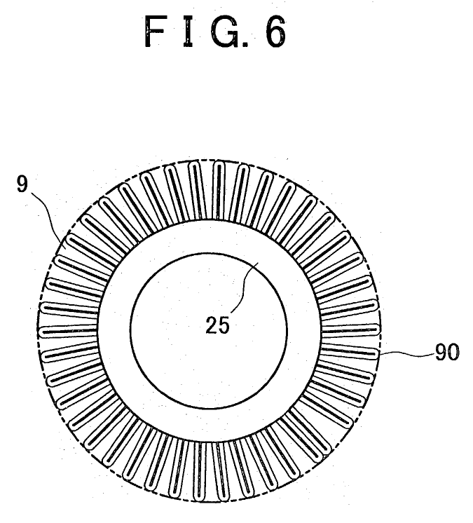

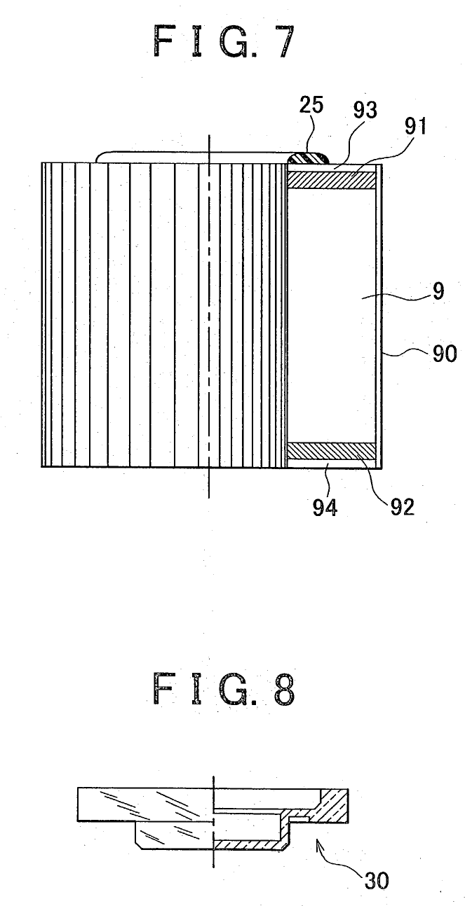

After that, as shown in FIG. 6 and FIG. 7, photo-curing resin 25 is applied to an upper surface of the cylindrical element 9 (FIG. 6 and FIG. 7).

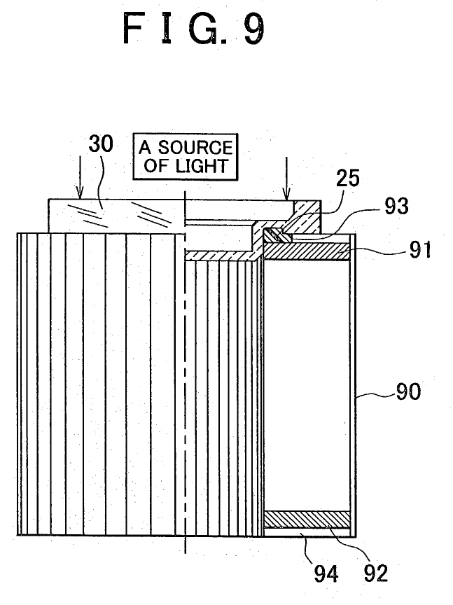

Next, a transparent mold 30 is pressed on the upper surface of the element 9 as shown in FIG. 8. By doing so, the photo-curing resin 25 is pressed into the upper edge portion 93. Ultraviolet irradiation is conducted in this condition (FIG. 9).

Thus, the photo-curing resin 25 is hardened and becomes the seal portion 15, and the seal portion 15 is integrally formed on the upper surface of the element 9 along with the resin between the adjacent ribs 90 and in the non-woven fabric. Using the same method, the seal portion 16 is also integrally formed on the lower surface of the element 9.

In this manner, the seal portions 15 and 16 are formed on the upper surface and the lower surface of the element 9 (FIG. 3).

After that, the element 9 on which the seal portions 15 and 16 are integrally formed is attached to a periphery side of a metal cylinder member 8 having a plurality of through holes. In this manner, the filter body 5 of the first embodiment is obtained. After that, it is set as shown in FIG. 1. Thus, the oil filter 1 according to the embodiment shown in FIG. 1 is obtained.

(4) Effects of the Filter Body and the Oil Filter

In the filter body 5 of the embodiment, the seal portions 15 and 16 are integrally formed on the inner edge portion of the upper surface of the element 9. Therefore, it is not necessary to attach a seal body separated from the filter body 5 when installing the filter body 5 to produce the oil filter shown in FIG. 1. As a result, it is possible to shorten production time of the fluid filter.

The oil filter according to the embodiment uses photo-curing resin as the material for the seal portions 15 and 16. Also, the hardness of the seal portions 15 and 16 has an appropriate elasticity of 10 to 70 in accordance with ISO 7619, resulting in excellent sealability. Further, because the upper surfaces of the seal portions 15 and 16 are flat, the sealability is excellent.

(5) Effects of the Production Method of the Filter Body

According to the production method of the embodiment, the seal portion 15 (16) is formed by applying the photo-curing resin to the upper surface (lower surface) of the element 9, and irradiating light to harden the photo-curing resin that has been applied. As a result, it is possible to form the seal portion 15 (16) on the upper surface (lower surface) of the element 9 without applying heat to the element 9. Further, because the photo-curing resin hardens faster than thermosetting resin which hardens at room temperature, it is possible to shorten the production time of the filter body. Also, because the mold 30 is pressed on the upper surface (lower surface) of the element 9, it is possible to form the seal portion with outstanding surface smoothness.

[Second Embodiment]

(1) Filter Body Structure

A filter body according to a second embodiment will be explained. Because the overall basic structure of an oil filter in the second embodiment is the same as that in the first embodiment, the explanation of the oil filter is omitted.

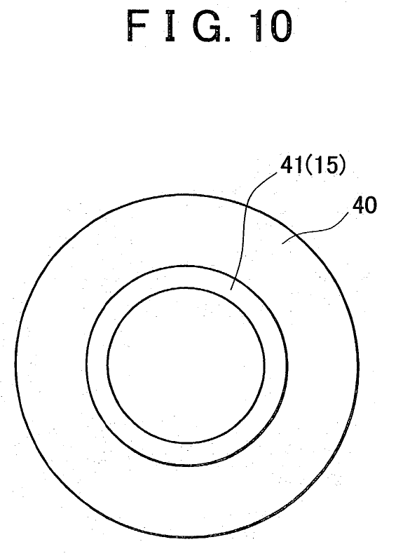

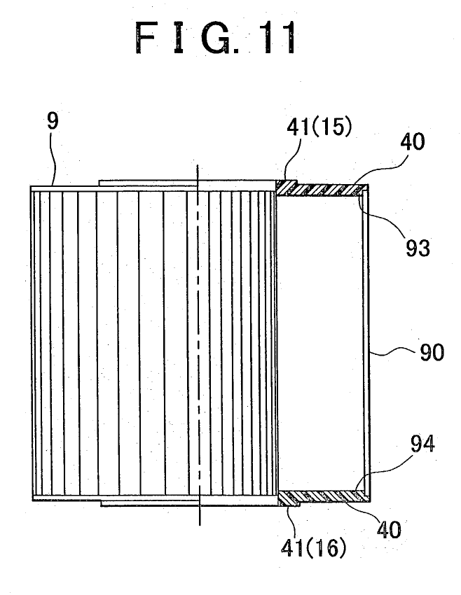

As shown in FIGS. 10 and 11, the filter body 5 according to the embodiment has a disc portion 40 that is formed (hardened) of photo-curing resin on all of the upper surface and the lower surface (including the upper surface and the lower surface between adjacent ribs) of the cylindrical element 9 having ribs that extend radially, and a convex portion 41 is formed on the inner edge portion of the disc portion 40. A portion of the photo-curing resin of the disc portion 40 slightly penetrates an upper edge portion 93 and a lower edge portion 94. The convex portions 41 functions as the seal portions 15 and 16 respectively, and the portions of the photo-curing resin of the disc portion 40 that penetrate the upper edge portion 93 and the lower edge portion 94 function respectively as an adhesive layer.

(2) Filter Body Production Method and Installation Thereof

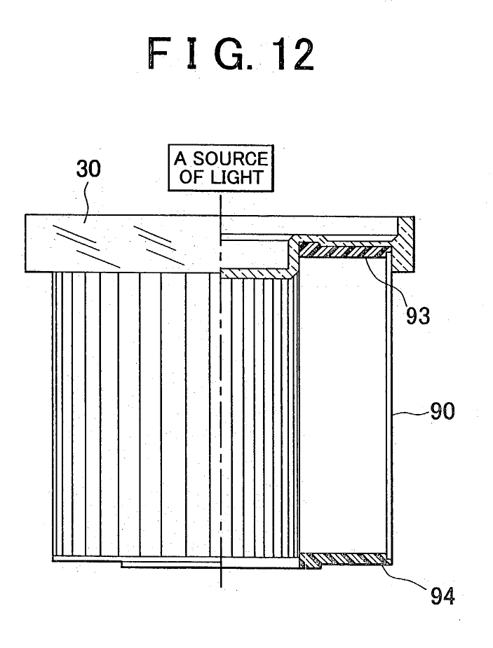

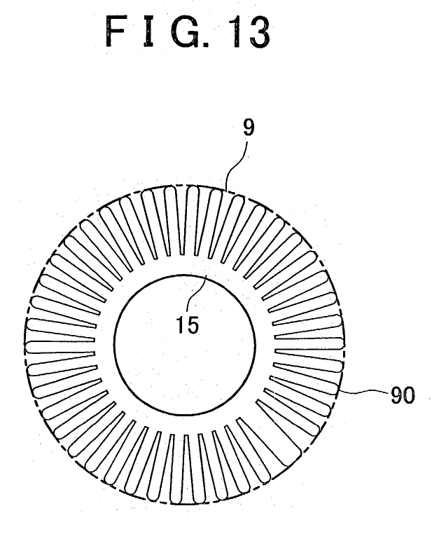

First, the filter medium that is made of non-woven fabric is folded to produce a cylindrical folded body having ribs that extend radially. After that, photo-curing resin (ultraviolet-curing type acrylic resin or the like) is applied to all of the upper surface of the folded body. Thus, a part of the photo-curing resin penetrates the inner portion of the folded body and reaches the upper edge portion 93 on the inner surface of the rib portion. For the photo-curing resin, resin (one that has a larger polymerization degree and higher viscosity than that in the first embodiment) is employed that has a viscosity that will prevent the resin from falling downward from between outer surfaces of the adjacent ribs 90 when applying the resin. After that, a mold 30 which is the same as that in the first embodiment is pressed on the upper surface of the folded body, and ultraviolet irradiation is conducted to the photo-curing resin through the mold 30 in this condition (FIG. 12).

By doing so, the disc portion 40 that is made of a hardened photo-curing resin is formed on the upper surface of the folded body. At this time, the seal portion 15 is integrally formed on the upper surface of the element 9. Further, all of the upper edge portion 93 of the inner portion of the ribis filled with the photo-curing resin that has penetrated the inner portion of the element 9. The same process is also conducted for the lower surface of the element 9. The element 9 where the seal portions 15 and 16 are formed is attached to the periphery side of a metallic cylinder member 8 having a plurality of through holes. In this manner, the filter body 5 according to this embodiment is formed. The filter body 5 is then installed in the same manner as in the first embodiment.

(3) Effects

In the filter body 5 according to this embodiment, the inner surfaces of the rib 90 are attached each other at the upper edge portion 93 and the lower edge portion 94 using the photo-curing resin within the disc portion 40 that exists on the upper edge portion 93 and the lower edge portion 94 of the inner surfaces of the rib and the resin that has penetrated the inner portion of the element 9. Thus, within the disc portion 40, the photo-curing resin that has entered between the inner surfaces of the rib and the photo-curing resin that has penetrated the element 9 function as the adhesive layer. Therefore, because the photo-curing resin that is applied to the upper surface and the lower surface has the functions of both the seal portion 15 (16) and the adhesive layer, in the production method according to the embodiment, the process for applying a different adhesive can be omitted, thereby allowing the production time to be shortened.

[Third Embodiment]

Next, a filter body 5 according to a third embodiment will be explained. Further, because the basic structure of the oil filter in the third embodiment is the same as that in the first embodiment, the explanation of the oil filter is omitted.

(1) Filter Body Structure

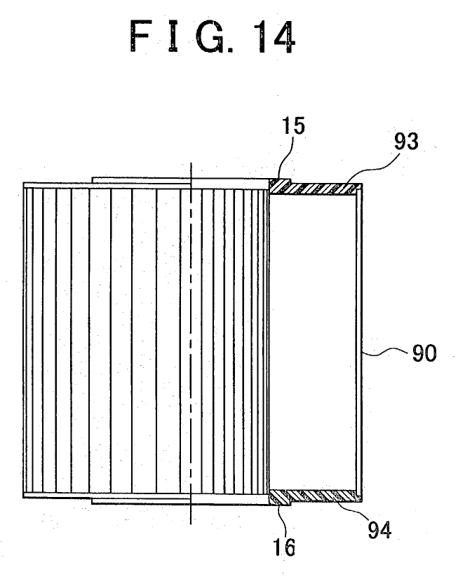

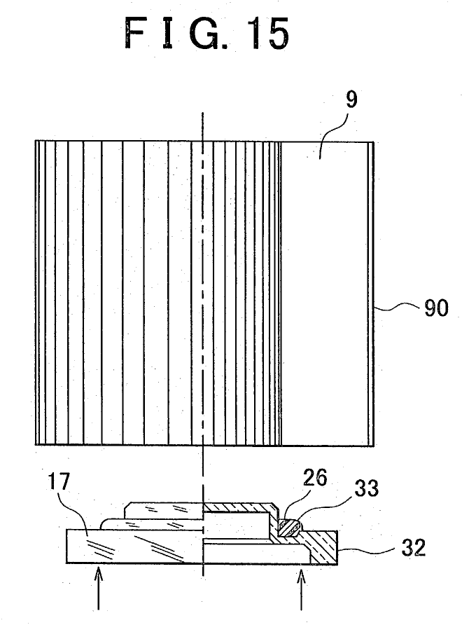

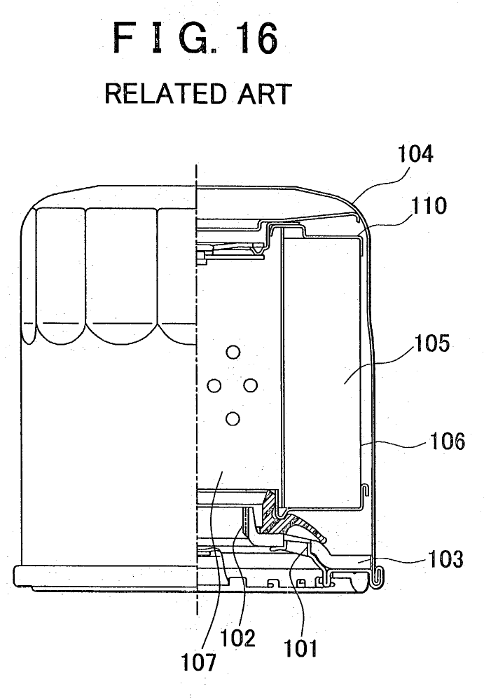

In the filter body 5 according to the embodiment, as shown in FIGS. 13 and 14, photo-curing resin is applied along radial direction of the ribs 90 on the upper surface and the lower surface of the cylindrical element 9 having ribs that extend radially, and inner surfaces of the rib 90 are attached each other by the photo-curing resin at the upper edge portion 93 and the lower edge portion 94. On the upper surface and the lower surface of the filter body 5, the seal portions 15 and the seal portion 16 made of the same resin as the photo-curing resin applied to the upper surface are formed.

(2) Filter Body Production Method and Assembly

First, a cylindrical folded body having ribs that extend radially is produced in the same manner as in the second embodiment.

After that, the photo-curing resin (ultraviolet-curing type acrylic resin or the like) is applied to the upper surface of the folded body along the upper surface of the ribs (FIG. 13). The photo-curing resin used at this time has a lower viscosity than the resin according to the second embodiment, and can easily penetrate the folded body. Thus, a part of the photo-curing resin penetrates the inner portion of the folded body, and the photo-curing resin that penetrates functions as the adhesive that attaches the inner surfaces of the ribs 90 each other at the upper edge portion 93. After that, the same mold 30 as that in the first embodiment is pressed on the upper surface of the element 9, and in this condition ultraviolet irradiation is conducted and the photo-curing resin is hardened (FIG. 12).

At this time, the inner surfaces of the rib 90 are attached at the upper edge portion vicinity 91 by the photo-curing resin that has penetrated the element 9, and the seal portion 15 is integrally formed by the photo-curing resin that does not penetrate the element 9 and remains on the upper surface. The same process is then conducted for the lower surface of the element 9, and the inner surfaces of the rib 90 are attached at the upper edge portion vicinity 91, and the seal portion 16 is integrally formed on the lower surface of the element 9. After that, the element 9 is attached to the outer periphery side of the metallic cylinder member 8 having a plurality of through holes. In this manner, the filter body 5 according to this embodiment is formed. After that, it is installed in the same manner as in the first embodiment and the second embodiment.

(3) Effects

According to the filter body 5 and its production method in the third embodiment, because the viscosity of the photo-curing resin is comparatively low, it is possible for even more photo-curing resin to penetrate the inner portion of the element 9. Therefore, the resin can be applied along the ribs to the upper surface (lower surface) of the element 9, and thus, it is possible to reduce the amount of photo-curing resin that is used.

Also, it is easy to adjust the viscosity of the photo-curing resin, and it is possible to easily produce resins with different viscosities. Thus, the element according to the embodiment can be easily produced.

[Fourth Embodiment]

Next, a filter body 5 according to a fourth embodiment will be explained.

(1) Filter Body Production Method and Installation Thereof

First, a cylindrical folded body having ribs that extend radially is produced in the same manner as in the second embodiment. After that, a groove portion 33 which is formed in a transparent mold 32 is filled with photo-curing resin 26 (ultraviolet-curing type acrylic resin or the like). At this time, it is acceptable to use resin with the same viscosity as the resin in the third embodiment for the photo-curing resin 26. However, resin with a viscosity lower than the photo-curing resin according to the third embodiment is used. In this embodiment, the resin with a small degree of polymerization, or resin to which a solvent has been mixed to lower the viscosity. The resin is irradiated with ultraviolet light with the mold 32 pressed on the lower surface of the folded body (FIG. 15).

Thus, the seal portion 16 is integrally formed on the cylindrical element 9 having ribs that extend radially. After that, the element 9 is reversed from top to bottom, and the seal portion 15 is integrally formed on the upper surface of the element 9 in the same manner. Further, according to the embodiment, seal portions 15 and 16 are formed by moving the mold 32 upward and pressing the mold 32 on the lower portion of the element 9, but it is also acceptable to move the element 9 downward and press it on the mold 32.

(2) Effects of the Filter Body and Production Method

In the second and third embodiments, because the mold 30 is pushed downward from the top to the folded body, there is a possibility of the photo-curing resin that is applied to flow downward, and in order to prevent this, resin with a high viscosity needs to be used. To deal with this, according to the production method of the fourth embodiment, because the mold 32 is pressed on the lower portion of the element 9 by pushing up the mold 32, the photo-curing resin does not flow down unlike in the second and third embodiments. Thus, photo-curing resin with an even lower viscosity can be used. In other words, photo-curing resin that easily penetrates the inner portion of the element 9 can be used. Therefore, even with a low viscous photo-curing resin, it is possible to form the seal portions 15 and 16 with strong sealability, and further it is possible to improve the adhesiveness of the upper edge portion 91 (lower edge portion 92) on the inner surfaces of the rib 90.

Further, the invention is not limited to the embodiments described above, and it is possible to have various different embodiments within the scope of the invention in accordance with the objective and application. For example, the above embodiment is a device for filtering oil. However, the application of the invention is not limited to a device for filtering oil, and the invention can be applied to a device for filtering air and the like. In other words, the fluid filter of an emboyment according to the invention can be used as a liquid filter such as an oil filter used in an automobile, and as a gas filter such as an air filter that can be used as a component of an air cleaner installed in an intake system of an internal combustion engine.

Further, the structure of the oil filter according to the above embodiments is a spin-on type oil filter. However, the structure of the oil filter is not limited to this structure.

Also, the “storage body”, the “upper support portion”, and the “lower support portion” are not limited to the structures in the above embodiments, and a different appropriate structure can be used according to the application.

Also, in the above embodiments, ultraviolet-curing type acrylic resin and acrylic silicone resin are used as the photo-curing resin that constitutes the seal portion. However, in addition, ultraviolet-curing type unsaturated polyester resin, further, electron beam-curing type unsaturated polyester resin, acrylic resin, silicone resin and fluorine resin, and acrylic polyester resin, acrylic urethane resin, acrylic epoxy resin, and acrylic polyether resin can be used. Also, in the first embodiment, non-photo-curing resin is used as the adhesive for attaching the inner surfaces of the rib at the vicinity of the upper edge portion (lower edge portion). However, photo-curing resin, such as ultraviolet-curing type acrylic resin, ultraviolet-curing type unsaturated polyester resin, and ultraviolet-curing type silicone polyester resin can be used. Thus, the time needed for attaching inner surfaces of the rib 90 at the upper edge portion and lower edge portion and their vicinity can be shortened. Further, because photo-curing resin is used in both the formation of the seal portions 15 and 16 and the attaching process, the time needed for the production process of the filter body can be shortened. Also, according to the first embodiment, the inner surfaces of the rib are attached each other at only the vicinity of the upper edge portion (lower edge portion). However, the inner surfaces of the rib may be attached up to the upper edge portion (the lower edge portion).

The hardness of the seal portion may be 10 to 70 in accordance with ISO 7619, preferably 20 to 60, and more preferably 30 to 60.

A seal portion formed of resin with or without solvent may be used as the seal portion 15 and/or 16. However, a seal portion formed of resin without solvent is higher sealability than a seal portion formed of resin with solvent. Therefore, it is preferable that a seal portion formed of resin without solvent be used as the seal portion 15 and/or 16.

Because a seal portion formed by photo-curing resin peals off a transparent mold in the above embodiments, it is possible to form a seal by the photo-curing resin on an upper surface portion of a filter where light does not easily reach.

What is claimed is:

1. A filter body stored in a storage body, comprising
a cylindrical element having ribs that extend radially, inner surfaces of the rib being attached each other by adhesive at both of at least one of an upper portion of the rib and vicinity thereof and at least one of a lower edge portion of the rib and vicinity thereof, and
a seal portion that is formed of photo-curing resin on at least one of an upper surface and a lower surface of the element and contacts the storage body and seals between the element and the storage body.

2. The filter body according to claim 1, wherein hardness of the seal portion is 10 to 70 in accordance with ISO 7619.

3. The filter body according to claim 1, wherein the adhesive is photo-curing resin.

4. The filter body according to claim 1, wherein the element is formed of a filter medium.

5. A production method of a filter body including a cylindrical element having ribs that extend radially, inner surfaces of the rib being attached each other by adhesive at both of at least one of an upper portion of the rib and vicinity thereof and at least one of a lower edge portion of the rib and vicinity thereof, and a seal portion that seals between the element and the storage body, comprising
preparing the element, and
forming the seal portion of photo-curing resin on at least one of the upper surface and the lower surface of the element.

6. The production method according to claim 5, wherein the photo-curing resin is applied to an upper surface portion and a lower surface portion of the element, then a transparent mold is placed on the upper surface and the lower surface, and the photo-curing resin is photo-hardened in this condition, whereby the seal portions are formed.

7. The production method according to claim 6,
wherein the photo-curing resin is applied to at least an inner periphery side edge portions of the upper surface portion and the lower surface portion of the element, and
then the transparent mold is placed on the upper surface and the lower surface, and the photo-curing resin is photo-hardened in this condition so as to form the seal portions.

8. The production method according to claim 5, wherein the adhesive is photo-curing resin.

9. The production method according to claim 5, wherein
the photo-curing resin is applied to at least a portion where ribs are formed in the upper surface portion and the lower surface portion of a cylindrical folded body having ribs that extend radially, and
a transparent mold is placed on an upper surface portion and a lower surface portion of the folded body, the photo-curing resin is photo-hardened in this condition so as to form the seal portions while the inner surfaces of the rib are attached each other by photo-curing resin at both the upper portion of the rib and vicinity thereof and at least one of the lower edge portion of the rib and vicinity thereof.

10. The production method according to claim 5, further comprising preparing a mold having a groove for forming the seal portions wherein
the photo-curing resin is filled in the groove, and at least a portion where ribs are formed in an upper surface portion and a lower surface portion of a cylindrical folded body is impregnated with the photo-curing resin, and
the resin is photo-hardened in this condition so as to form the seal portions while the inner surfaces of the rib are attached each other by photo-curing resin at both the upper portion of the rib and vicinity thereof and at least one of the lower edge portion of the rib and vicinity thereof.

11. A fluid filter comprising:
the filter body according to claim 1;
a storage body for storing the filter body;
an upper support portion for supporting the filter from above; and
a lower support portion for supporting the filter from below, wherein the seal portions seal between the upper support portion and the upper surface of the element, and between the lower support portion and the lower surface of the element.

12. A fluid filter comprising:
the filter body manufactured by the method according to claim 5;
a storage body for storing the filter body;
an upper support portion for supporting the filter from above; and
a lower support portion for supporting the filter from below, wherein the seal portions seal between the upper support portion and the upper surface of the element, and between the lower support portion and the lower surface of the element.
